(19) United States
(12) Patent Application Publication
(10) Pub. No.: US 2009/0095269 A1
(43) Pub. Date: Apr. 16, 2009

(54) Two-Cycle Engine

(75) Inventor: Ryouji Zama, Saitama (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: ZENOAH CO., LTD., Kawagoe-shi (JP)

(21) Appl. No.: 11/920,334

(22) PCT Filed: Dec. 26, 2006
(86) PCT No.: PCT/JP2006/325916

§ 371 Date: Nov. 13, 2007

(30) Foreign Application Priority Data
Dec. 28, 2005 (JP) 2005-380258

(51) Int. Cl. F02B 33/04

(52) U.S. Cl. 123/73 A

(57) ABSTRACT

In a stratified scavenging two-cycle engine 1 whose crankshaft 30 is cantilevered, a crankcase 20 is provided with an opening 23 for housing the crankshaft 30, and a thick wall of the crankcase 20 is provided with a crankcase air passage 24. The opening 23 is fitted with a carburetor mount 50 that allows mounting a carburetor 70. Since the carburetor mount 50 covering the opening 23 of the crankcase 20 functions also as an alternative for a conventional insulator, there is no need to prepare a separate insulator, thereby reducing the number of components. Moreover, since the crankcase 20 is lower in temperature than the cylinder 10 in which combustion takes place, the carburetor mount 50 functioning as an insulator can be thinner, thereby downsizing the engine 1.

### TECHNICAL FIELD

The present invention relates to a two-cycle engine, and in particular, to a two-cycle engine which is cantilevered type with a crankshaft supported by a crankcase at only one end of the crankshaft and stratified scavenging type as well.

### BACKGROUND ART

A conventional two-cycle engine may be arranged with a crankshaft supported by a crankcase at only one end of the crankshaft.

Although a cantilevered crankshaft arrangement, only allowing a small displacement, can only be utilized in a small power engine that does not load much on the crankshaft in operation, the arrangement is effective for downsizing an engine.

A stratified scavenging type is also known as one of the two-cycle engines (e.g., Patent Document 1).

The stratified scavenging two-cycle engine includes an air passage communicating to a scavenging passage to supply lead air to the scavenging passage before scavenging. The lead air supplied is the first to scavenge combustion gas in a cylinder. While scavenging combustion gas by air-fuel mixture accompanies exhaust of unburned fuel in the air-fuel mixture, the stratified scavenging does not accompany such exhaust, thereby improving fuel efficiency.

[Patent Document 1] International Publication No. WO98/57053 (pages 5 to 11)

### DISCLOSURE OF THE INVENTION

### Problems to be Solved by the Invention

Since a two-cycle engine with a small displacement is, generally speaking, often used for portable working machinery and the like, a smaller two-cycle engine is desirable. Since an engine is, however, equipped with a carburetor, an insulator and the like for restraining heat transfer to the carburetor, a cantilevered engine is not yet sufficiently compact as a whole with all the attachments, which leaves a strong desire for downsizing the entire engine. Downsizing a stratified scavenging two-cycle engine, prospected to be a mainstream engine of the kind, is especially urgent.

An object of the present invention is to provide a stratified-scavenging and cantilevered two-cycle engine which contributes toward the downsizing.

### Means for Solving the Problems

A two-cycle engine according to an aspect of the present invention is a cantilevered stratified scavenging two-cycle engine having a crankshaft supported to a crankcase in a cantilevered manner, including: a scavenging passage provided to a cylinder for communicating a cylinder chamber and an interior portion of the crankcase with each other; a carburetor mount to which a carburetor can be mounted, the carburetor mount covering an opening provided to the crankcase for housing the crankshaft; and an air passage for communicating the scavenging passage and a carburetor mount air passage provided to the carburetor mount for delivering lead air.

In the above aspect of the invention, since the carburetor mount covering the opening of the crankcase functions also as an alternative for a conventional insulator, there is no need to prepare a separate insulator, thereby reducing the number of components to allow downsizing. Moreover, since the crankcase is lower in temperature than the cylinder in which combustion takes place, the carburetor mount functioning as an insulator can be thinner, thereby securely downsizing the engine. In addition, since the carburetor mount air passage and the scavenging passage are communicated through the air passage, the function as the stratified two-cycle engine can be preserved.

In the above arrangement, each of the carburetor mount, the crankcase and the cylinder that are integrally assembled may have a thick wall through which the air passage passes to intercommunicate the air passage, the carburetor mount, the crankcase and the cylinder.

In the aspect of the invention, since the engine is provided with an air passage which communicates passing through thick walls of the cylinder, the crankcase, and the carburetor mount, the air passage can be integrated with the engine without being exposed to the outside of the engine, thereby enabling downsizing.

In the above arrangement, a portion of the air passage disposed at the thick wall of the crankcase may be formed by a groove provided to one of the crankcase and the cylinder and a wall provided to the other for covering the groove.

In the above arrangement, a portion of the air passage disposed at the thick wall of the crankcase may be formed by a groove provided to one of the crankcase and the carburetor mount and a wall provided to the other for covering the groove.

In the aspect of the invention, since at the thick wall of the crankcase, the air passage is formed by a groove provided to any of the crankcase, the cylinder, or the carburetor mount and a wall provided for covering the groove, the structure is simplified as compared to a structure with a penetrating hole through the thick wall, thereby facilitating manufacturing process.

In the above arrangement, the two-cycle engine may include: a scavenging passage core hole provided as an opening into an outside of the cylinder for forming a scavenging port, the scavenging port being an opening into the cylinder chamber of the scavenging passage; and an air passage core hole provided as an opening into the outside of the cylinder for forming an air intake port, the air intake port being an opening into the cylinder chamber of a portion of the air passage disposed at a thick wall of the air passage; in which the scavenging passage core hole and the air passage core hole are provided adjacent to each other and covered by a singular cover.

In the above aspect of the invention, since the scavenging passage core hole for forming the scavenging port and the air passage core hole for forming the air intake port are provided to the cylinder adjacent to each other and the core holes are covered by a singular cover, the core holes need not be covered by separate covers, thereby preventing an increase in the number of components.

In the above arrangement, the air passage may include a tube crawling on outsides of the crankcase and the cylinder.

In the above aspect of the invention, since the air passage includes a tube crawling on the outsides of the crankcase and the cylinder, the direct communicative connection by the tube of the carburetor mount air passage and the scavenging passage unnecessitates the air passage in the thick wall of the cylinder or the crankcase, thereby simplifying the structure of the air passage to facilitate manufacturing process.

### BRIEF DESCRIPTION OF DRAWINGS

FIG. 1 shows an exploded perspective of a two-cycle engine according to a first embodiment of the present invention;

FIG. 2 shows an exploded perspective of the two-cycle engine from another direction;

FIG. 3 shows a perspective of a cylinder;

FIG. 4 shows a half sectional perspective of the cylinder;

FIG. 5 is a perspective of the cylinder in FIG. 4 viewed from inside;

FIG. 6 shows an exploded perspective of a two-cycle engine according to a second embodiment of the present invention;

FIG. 7 shows an exploded perspective of a two-cycle engine according to a third embodiment of the present invention;

FIG. 8 shows an exploded perspective of a two-cycle engine according to a fourth embodiment of the present invention; and

FIG. 9 shows an exploded perspective of a two-cycle engine according to a fifth embodiment of the present invention.

### EXPLANATION OF CODES

1 . . . two-cycle engine, 4 . . . air passage, 10 . . . cylinder, 13 . . . scavenging passage, 18 . . . air passage core hole, 20 . . . crankcase, 23 . . . opening, 30 . . . crankshaft, 50 . . . carburetor mount, 54 . . . carburetor mount air passage, 58 . . . tube 60A, 60B . . . cover, 130 . . . scavenging port, 131 . . . scavenging passage core hole, 140 . . . air intake port

### BEST MODE FOR CARRYING OUT THE INVENTION

### First Embodiment

A first embodiment of the present invention will be described below with reference to the drawings.

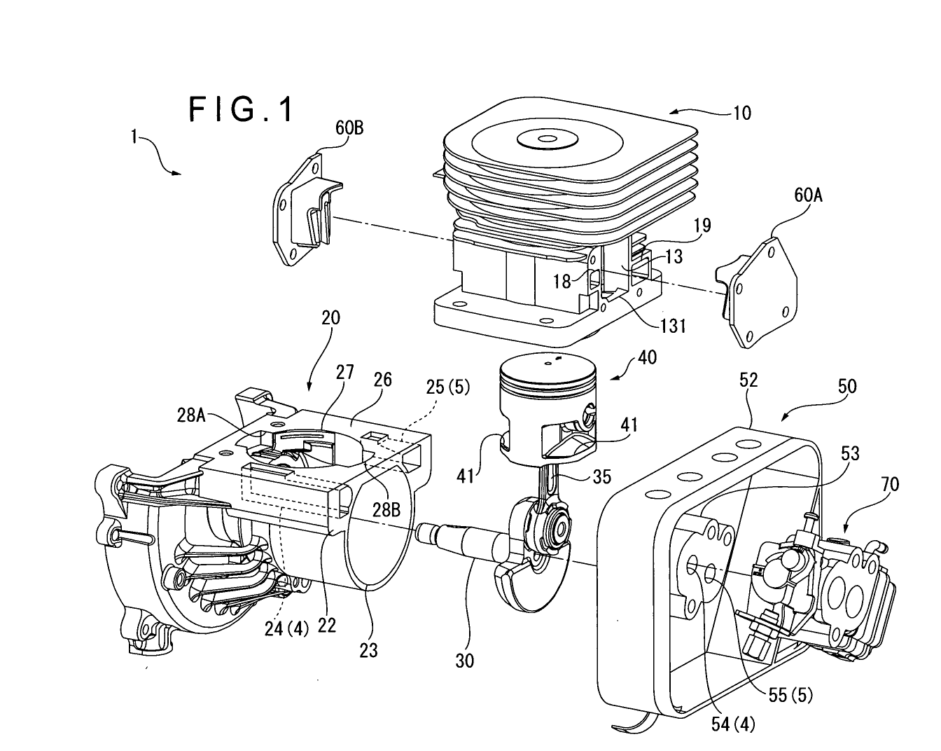

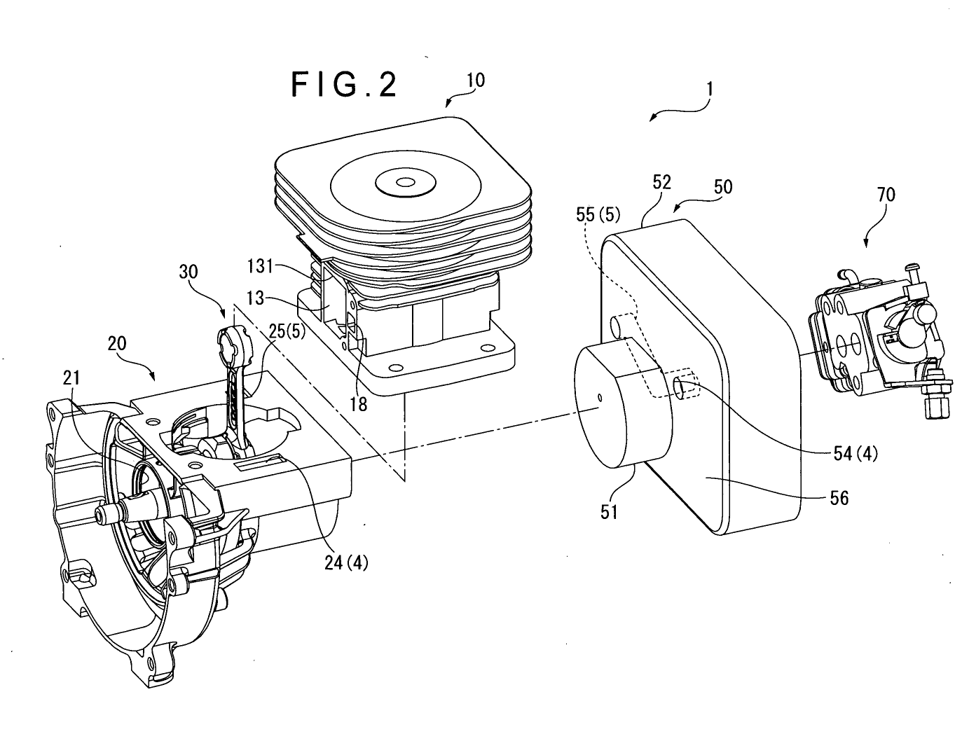

FIG. 1 shows an exploded perspective of a stratified scavenging two-cycle engine 1 according to the embodiment. FIG. 2 shows an exploded perspective of the two-cycle engine 1 viewed from another direction.

As shown in FIGS. 1 and 2, the stratified scavenging two-cycle engine 1 includes: a cylinder 10 having a cooling fin; a crankcase 20 provided under the cylinder 10 (in the Figures); a crankshaft 30 placed in the crankcase 20 and supported only at one end of the crankshaft; a piston 40 connected to the crankshaft 30 via the cylinder 10 and slidably inserted in the cylinder 10; and a carburetor mount 50 attached to the crankcase 20 at an opposite side of the crankcase with respect to the side to which the crankshaft 30 is supported. A carburetor 70 is mounted to the carburetor mount 50.

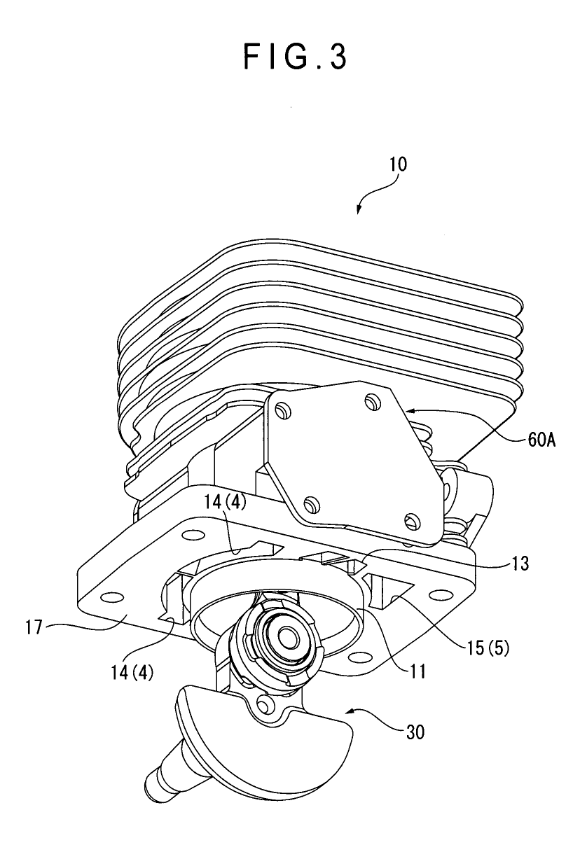

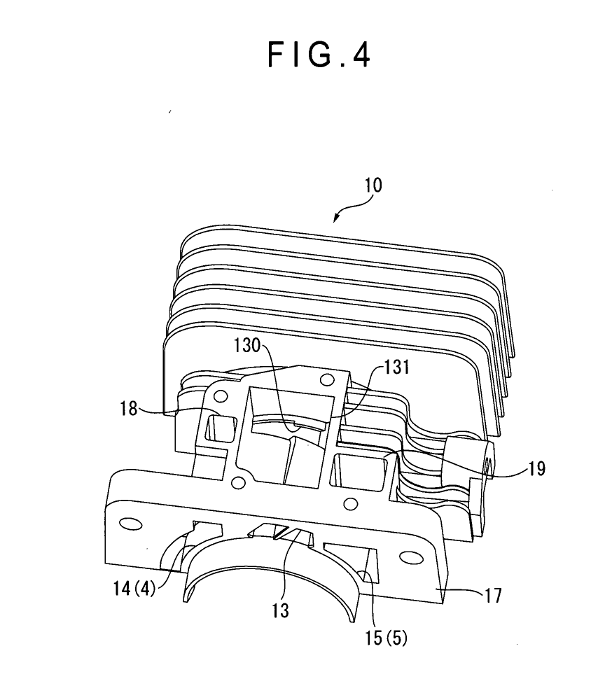

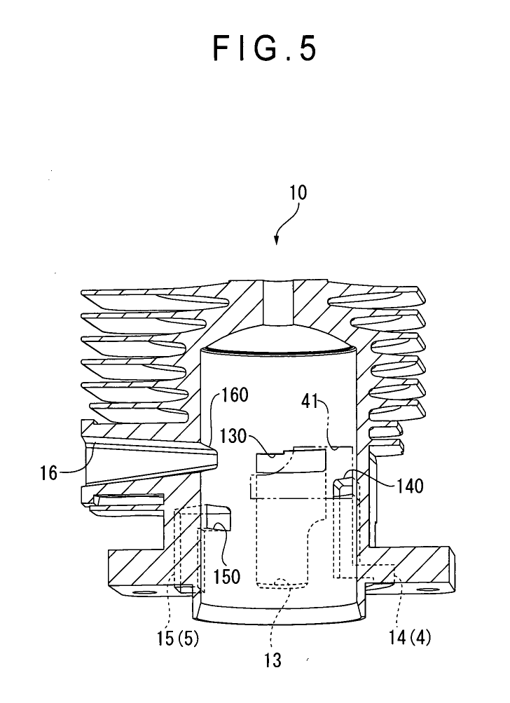

FIG. 3 is a perspective of the cylinder 10. FIG. 4 is a half sectional perspective of the cylinder 10. FIG. 5 is a perspective of the cylinder 10 of FIG. 4 viewed from inside.

As shown in FIG. 3, the cylinder 10 includes: a connection surface 17 for connection with the crankcase 20 (FIGS. 1 and 2); a liner 11 projecting from the connection surface 17; a scavenging passage 13 which has two divided openings around the liner 11; a pair of cylinder air passages 14 which also have openings around the liner 11; a cylinder mixture passage 15 which has still another opening around the liner 11; and an exhaust passage 16 which opens on the inner surface of the cylinder 10 to form an exhaust port 160 as shown in FIG. 5. Another cylinder air passage 14 is also provided at radially opposed position around the cylinder 10, which is not shown behind the liner 11 in FIG. 3.

In FIGS. 3 to 5, the scavenging passage 13 opens on the inner surface of the cylinder 10 to form a scavenging port 130 and diverges to open to the outside of the cylinder 10 to form a scavenging passage core hole 131. The scavenging passage core hole 131 is a hole used for a core when the scavenging port 130 is formed.

The cylinder air passage 14 opens on the inner surface of the cylinder 10 to form an air intake port 140. The cylinder air passage 14 diverges to open to the outside of the cylinder 10 to form an air passage core hole 18. The air passage core hole 18 is a hole used for a core when the air intake port 140 is formed.

The cylinder mixture passage 15 opens on the inner surface of the cylinder 10 to form a mixture intake port 150. The engine 1 in the present embodiment is of the piston valve type in which the mixture intake port 150 opens and closes by the reciprocal movement of the piston 40. The cylinder mixture passage 15 diverges to open to the outside of the cylinder 10 to form a mixture passage core hole 19. The mixture passage core hole 19 is also a hole used for a core when the mixture intake port 150 is formed.

On a first side of the cylinder 10, a cover 60A covers the air passage core hole 18, the mixture passage core hole 19 and the scavenging passage core hole 131. On a second side of the cylinder 10, as shown in FIG. 2, the air passage core hole 18 in communication with the air intake port 140 is the only hole provided adjacent to the scavenging passage core hole 131, and the air passage core hole 18 and the scavenging passage core hole 131 are covered by a cover 60B. This is because the inner surface of the second side of the cylinder 10 is only provided with the scavenging port 130 and the air intake port 140 and not provided with the mixture intake port 150, the cylinder mixture passage 15 in communication with the mixture intake port 150, and the mixture passage core hole 19.

Although the unconventional core holes 18 and 19 are provided on the first side of the cylinder 10 in the embodiment, since the core holes 18 and 19 are provided adjacent to the scavenging passage core hole 131 with the scavenging core hole 131 in between, the core holes 18 and 19 and the conventional scavenging passage core hole 131 can be covered by a singular cover 60A, so that there is no need for a dedicated cover for each of the holes, thereby preventing an increase in the number of components. On the second side of the cylinder 10, since the air passage core hole 18 is also provided adjacent to the scavenging passage core hole 131, the air passage core hole 18 and the scavenging passage core hole 131 can be covered by a singular cover 60B, thereby preventing an increase in the number of components.

An opening 23 of the crankcase 20, provided to a connection surface 22 that connects with the carburetor mount 50, is sized so as to house the crankshaft 30 therein in assembling the engine 1. After the crankshaft 30 is placed in the crankcase 20, the opening 23 is covered by fitting a projection 51 projecting from the carburetor mount 50. An opening 27 of the crankcase 20, provided to a connection surface 26 that connects with the cylinder 10, is fitted with a lower end of the liner 11 of the cylinder 10. The crankcase 20 arranged as such is further provided with a crankcase air passage 24 and a crankcase mixture passage 25, which open around the openings 23 and 27 on the connection surfaces 22 and 26. The crankcase air passage 24 opening on the connection surface 26 communicates with the cylinder air passage 14, and the opening of the crankcase mixture air passage 25 on the connection surface 26 communicates with the cylinder mixture passage 15. In addition, the connection surface 26 is provided with recesses 28A and 28B, which communicatively connect with the scavenging passage 13 of the cylinder 10.

The piston 40 is provided with a pair of conduits 41 around the outer circumference thereof. As shown in FIGS. 1 and 5 (two dot phantom), the conduits 41 are sized so as to extend from the air intake port 140 to the scavenging port 130 and allow the ports 140 and 130 to communicate with each other

The carburetor mount 50, as shown in FIG. 2, includes; the projection 51; an exterior frame 52 which serves as an air cleaner case; an insulating portion 53 to which the carburetor 70 is attached for restraining heat transfer from the engine 1 to the carburetor 70; a carburetor mount air passage 54; and a carburetor mount mixture passage 55.

As shown in FIG. 2, the carburetor mount air passage 54 is formed along the axis of the crankcase air passage 24 and is communicatively connected with the crankcase air passage 24. The carburetor mount mixture passage 55 curves in the carburetor mount 50, and opens on the connection surface 56, which is a surface in connection with the crankcase, at a position that corresponds to the opening of the crankcase mixture passage 25.

In the present embodiment, eventually, an air passage 4 includes the carburetor mount air passage 54, the crankcase air passage 24, the cylinder air passage 14 and the conduit 41 of the piston 40, and a mixture passage 5 includes the carburetor mount mixture passage 55, the crankcase mixture passage 25 and the cylinder mixture passage 15. It should be appreciated that the air passage 4 and the mixture passage 5 exploit thick walls of the cylinder 10, the crankcase 20 and the piston 40 and even penetrate the thick walls of the cylinder 10 and the crankcase 20

As described above, since the engine 1 is provided with the passages 4 and 5 passing through the interior of the cylinder 10 and the crankcase 20, lead air and mixture can securely be supplied from the carburetor 70 mounted to the carburetor mount 50. In addition, since the carburetor mount 50 covering the opening 23 of the crankcase 20 functions also as an alternative for a conventional insulator, there is no need to prepare a separate insulator, thereby reducing the number of components. Moreover, since the temperature of the crankcase 20 is lower than that of the cylinder 10 where combustion takes place, the carburetor mount 50 functioning as an insulator can be thinner, thereby enabling downsizing the engine 1.

The movement of the engine 1 will be described below.

In the stratified scavenging two-cycle engine 1 arranged as described above, when the piston 40 moves from the bottom dead center toward the top dead center, the pressure starts to decrease in the crank chamber and increase in the cylinder chamber, and the scavenging port 130 and the exhaust port 160, opening into the cylinder chamber, close in sequence. While the air intake port 140 moves to the top dead center, the air intake port 140 acquire communication to the scavenging port 130 via the conduit 41 of the piston 40, and in the crankcase 20 the mixture intake port 150 opens to acquire communication to the crank chamber. As a consequence, scavenging lead air flows through the air passage 14, the air intake port 140 and the conduit 41 and intrudes into a portion of the scavenging passage 13, adjacent with respect to the scavenging port 130. The mixture flows through the mixture passage 5 to the mixture intake port 150, where the mixture is introduced into the crank chamber.

When the piston 40 ascends further and reaches the top dead center, the mixture in the cylinder 10 is ignited and combusted, and the resultant explosion causes the piston 40 to descend. Accordingly, the pressure starts to rise in the crank chamber. Besides, the mixture intake port 150 is closed by the piston 40 to discommunicate the scavenging port 130 and the air intake port 140 from each other.

As the piston 40 descends, the exhaust port 160 and the scavenging port 130 open into the cylinder chamber in sequence, so that, while combustion gas is exhausted through the exhaust port 160, the lead air staying in the scavenging passage 13 flows into the cylinder chamber by the increased pressure in the crank chamber to crowd out the residual combustion gas in the cylinder 10 through the exhaust port 160. Subsequently, the mixture in the crank chamber flows into the cylinder chamber through the recess 28 and the scavenging passage 13. The piston 40 then again starts to ascend from the bottom dead center, causing the pressure in the crank chamber to fall, the scavenging port 130 and the exhaust port 160 to close in sequence, and the above-described cycle to repeat.

### Second Embodiment

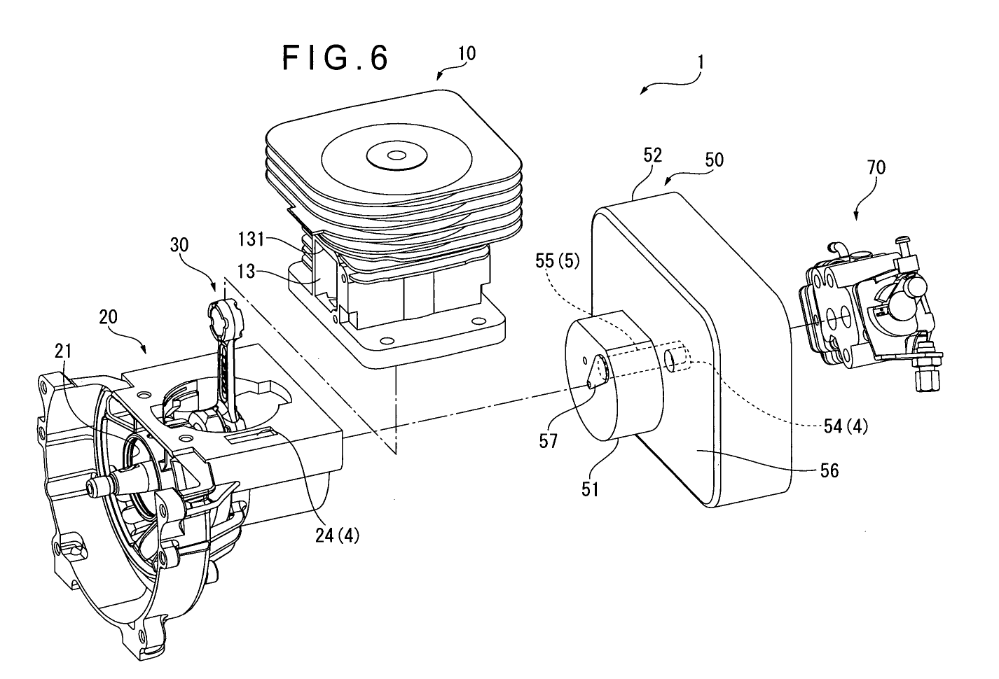

FIG. 6 shows an exploded perspective of a two-cycle engine according to a second embodiment of the present invention. In the following description, the same members and functional portions as those of the first embodiment will be denoted by the same reference numerals, and the description thereof will be omitted or simplified.

In the present embodiment, the mixture passage 5 opens directly into the crank chamber from the projection 51 of the carburetor mount 50, unlike in the first embodiment. In other words, the mixture passage 5 of the present embodiment is constituted only by the carburetor mount mixture passage 55. The projection 51 of the carburetor mount 50 is provided with a lead valve 57 for opening and closing the carburetor mount mixture passage 55. Only during compression stroke the lead valve 57 opens by the negative pressure in the crankcase to introduce mixture into the crankcase 20. In short, the engine 1 in the present embodiment is lead valve type.

The present embodiment has an arrangement similar to the first embodiment, so that similar effects can be obtained. In addition, since the mixture passage 5 directly communicates with the crank chamber from the carburetor mount 50, the cylinder mixture passage 15 and the crankcase mixture passage 25 found in the first embodiment need not be provided to the cylinder 10 and the crankcase 20. As a result, the structure of the crankcase 20 can be simplified, pressure loss can be eliminated in the mixture passage 5, and the operation of the engine 1 can be stabilized.

### Third Embodiment

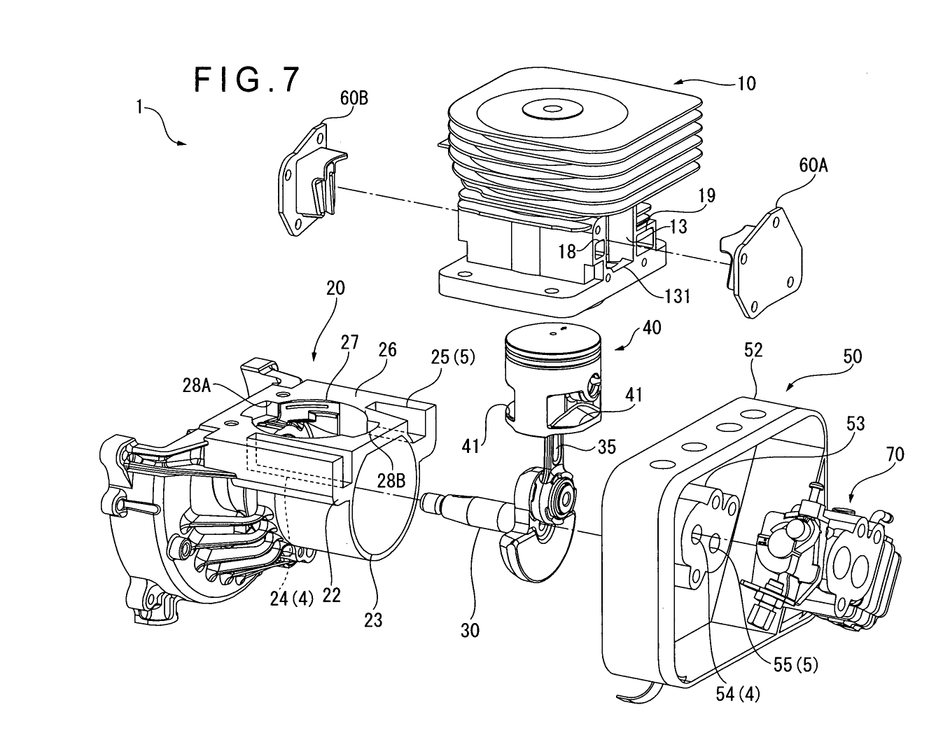

FIG. 7 shows an exploded perspective of a two-cycle engine according to a third embodiment of the present invention. In the engine 1 of the embodiment, the portions of the air passage 4 and the mixture passage 5 passing through the thick wall of the crankcase 20 are formed tunnel-like by grooves opening on the connection surface 26 and a groove-covering wall residing on the connection surface 17 of the cylinder 10. These tunnel-like portions are identified as the crankcase air passage 24 and the crankcase mixture passage 25.

The present embodiment can still have effects similar to the first embodiment since the passages 54 and 55 of the carburetor mount 50 can be communicatively connected with the passages 14 and 15 of the cylinder. In addition, the simplified structure without penetrating holes can facilitate manufacturing process.

### Fourth Embodiment

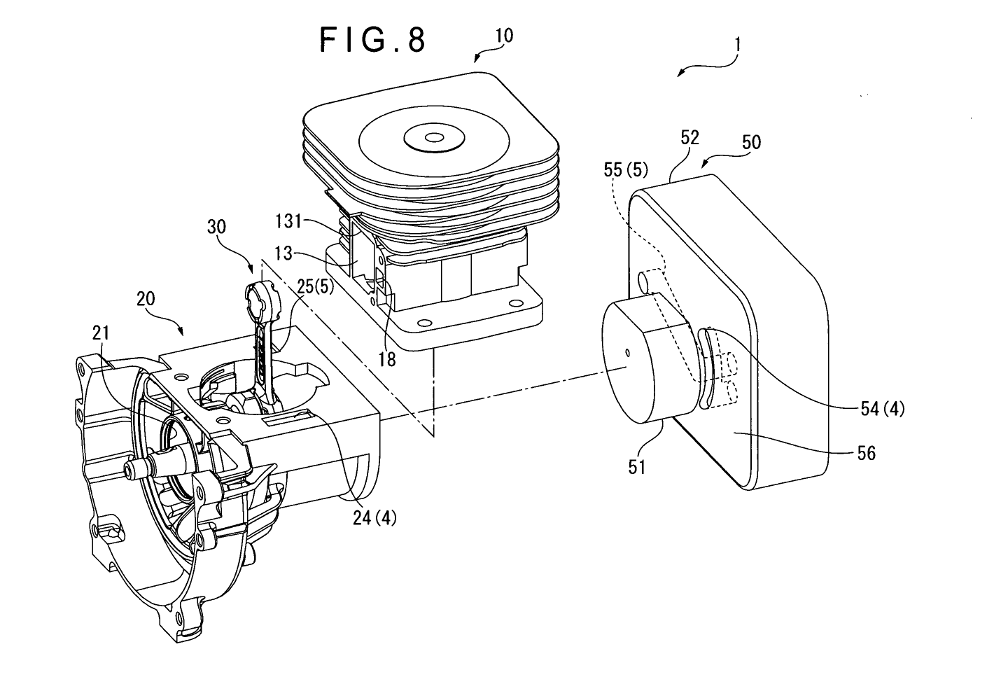

FIG. 8 shows an exploded perspective of a two-cycle engine according to a fourth embodiment of the present invention. In the engine 1 of the embodiment, the portion of the air passage 4 passing through the thick wall of the crankcase 20 is formed by a groove on the carburetor mount 50 and a groove-covering wall on the crankcase 20. The groove of the carburetor mount 50 is opening on a connection surface 56 that connects with the crankcase 20. The flange-shaped groove-covering wall of the crankcase 20 is formed around the opening 23.

The present embodiment can still have an arrangement and effects similar to the first embodiment since the groove on the carburetor mount 50 is covered by the groove-covering wall of the crankcase 20 so as to be tunnel-like.

### Fifth Embodiment

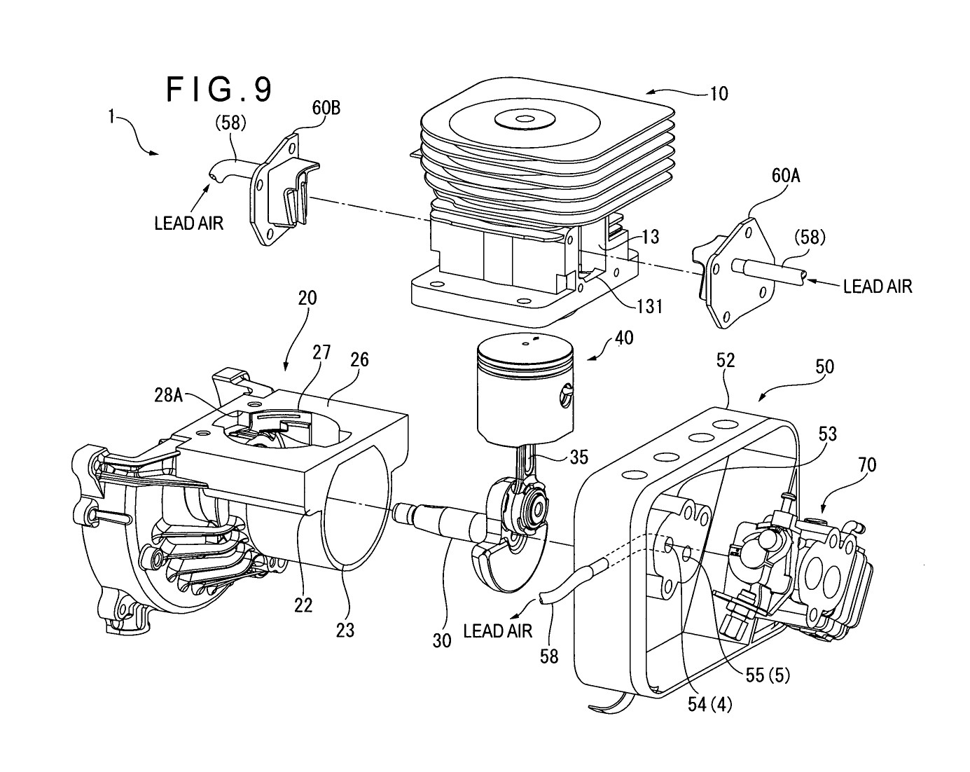

FIG. 9 shows an exploded perspective of a two-cycle engine according to a fifth embodiment of the present invention. The engine 1 of the embodiment is the lead valve type, and moreover, is provided with a tube 58, which extends through an exterior frame 52 of the carburetor mount 50 and the covers 60A and 60B but not through the cylinder 10 and provides direct communicative connection between the carburetor mount air passage 54 and the scavenging passage 13. In other words, the tube 58 branches off in the middle to send to the scavenging passages 13 the lead air coming from the carburetor air passage 54.

The present embodiment can still have an arrangement and effects similar to the first embodiment. In addition, since the carburetor mount air passage 54 directly communicates with the scavenging passage 13 via the tube 58, air passages need not be provided to the thick walls of the crankcase 20 and the cylinder 10, whereby the simplified structure of the air passage 4 facilitates manufacturing process.

It should be understood that the present invention be not limited to the above embodiments, but various modifications and improvements can be made insofar as an object of the present invention is achieved.

For example, while the tube 58 is connected to the carburetor mount 50 and the covers 60A and 60B to provide communication between the carburetor mount air passage 54 and the scavenging passage 13 in the fifth embodiment, the tube 58 may be implemented in any suitable manner, such as connecting the crankcase 20 to the cover 60 so as to communicate the crankcase air passage 24 with the scavenging passage 13 or connecting the carburetor mount 50 to the cylinder 10 so as to communicate the carburetor mount air passage 54 to the cylinder air passage 14.

### INDUSTRIAL APPLICABILITY

The present invention can be used for blowers, brushcutters, chainsaws and other portable work machinery as a stratified scavenging two-cycle engine whose crankshaft is supported by a crankcase at only one end of the crankshaft.

1. A cantilevered stratified scavenging two-cycle engine having a crankshaft supported to a crankcase in a cantilevered manner, comprising:
a scavenging passage provided to a cylinder for communicating a cylinder chamber and an interior portion of the crankcase with each other;
a carburetor mount to which a carburetor can be mounted, the carburetor mount covering an opening provided to the crankcase for housing the crankshaft; and
an air passage for communicating the scavenging passage and a carburetor mount air passage provided to the carburetor mount for delivering lead air.

2. The two-cycle engine according to claim 1, wherein each of the carburetor mount, the crankcase and the cylinder that are integrally assembled has a thick wall through which the air passage passes to intercommunicate the air passage, the carburetor mount, the crankcase and the cylinder.

3. The two-cycle engine according to claim 2, wherein a portion of the air passage disposed at the thick wall of the crankcase is formed by a groove provided to one of the crankcase and the cylinder and a wall provided to the other for covering the groove.

4. The two-cycle engine according to claim 2, wherein a portion of the air passage disposed at the thick wall of the crankcase is formed by a groove provided to one of the crankcase and the carburetor mount and a wall provided to the other for covering the groove.

5. The two-cycle engine according to claim 1, further comprising: a scavenging passage core hole provided as an opening into an outside of the cylinder for forming a scavenging port;
the scavenging port being an opening into the cylinder chamber of the scavenging passage; and
an air passage core hole provided as an opening into the outside of the cylinder for forming an air intake port, the air intake port being an opening into the cylinder chamber of a portion of the air passage disposed at a thick wall of the air passage; wherein
the scavenging passage core hole and the air passage core hole are provided adjacent to each other and covered by a singular cover.

6. The two-cycle engine according to claim 1, wherein the air passage is provided with a tube crawling on outsides of the crankcase and the cylinder.
